(19) United States
(12) Patent Application Publication
(10) Pub. No.: US 2013/0109725 A1
(43) Pub. Date: May 2, 2013

(54) GRANULES WITH IMPROVED DISPERSION PROPERTIES

(71) Applicant: DOW AGROSCIENCES LLC, Indianapolis, IN (US)

(72) Inventors: Hiteshkumar Dave, Carmel, IN (US); Lei Liu, Carmel, IN (US); Aaron Zettler, Indianapolis, IN (US)

(73) Assignee: DOW AGROSCIENCES LLC, Indianapolis, IN (US)

(21) Appl. No.: 13/664,790

(22) Filed: Oct. 31, 2012

Related U.S. Application Data
(60) Provisional application No. 61/554,008, filed on Nov. 1, 2011.

(51) Int. Cl. A01N 43/40

(52) U.S. Cl. 514/352

(57) ABSTRACT

Provided herein are methods and compositions for improving the dispersion properties in water of a pesticide-containing granule with a water soluble agglomeration suppressant.

### CROSS REFERENCE TO RELATED APPLICATION

This application claims priority to U.S. Provisional Patent Application Ser. No. 61/554,008, filed Nov. 1, 2011, the disclosure of which is hereby incorporated herein in its entirety by this reference.

### FIELD

Provided herein are methods of improving the dispersion properties in water of a pesticide-containing granule and the composition of such a granule. The described granule exhibits improved dispersibility in water and provides control of important target pests.

### BACKGROUND

Agrochemical formulations are generally designed based on customer needs and the physiochemical properties of the active ingredients, for example, the solubility of the active ingredient in water or non-aqueous solvents. There are two major categories of formulations, solid formulations and liquid formulations.

Solid formulations, such as granule formulations (GR) and water dispersible granule formulations (WG), containing pesticidal active ingredients are seeing increased use today because of their relative safety compared to liquid formulations and the advantages they offer with regard to cost savings in packaging and transportation, and the environmental benefits of eliminating the use of organic solvents. WG formulations are designed to readily disperse on contact with the water carrier in a spray tank and provide equivalent performance to an emulsifiable concentrate product. GR formulations are normally designed for broadcast application without prior dilution in a carrier such as water. Granule products may be used for insect, weed, fungal pathogen and nematode control in both water and non-water applications.

Agricultural granules containing pesticide active ingredients may also contain inert ingredients such as solid carriers, surfactants, adjuvants, binders and the like. These inert ingredients may include, for example, clays, starches, silicas, sulphates, chlorides, lignosulfonates, carbohydrates, alkylated celluloses, xanthum gums and guaseed gums, and synthetic polymers such as polyvinyl alcohols, sodium polyacrylates, polyethylene oxides, polyvinylpyrrolidones and urea/formaldehyde polymers like PergoPak® M (registered trademark of Albemarle Corporation). The active ingredients contained in WG products may include herbicides, insecticides, fungicides, plant growth regulators and safeners.

Adjuvants are important components of formulated agricultural products and are defined as substances which can increase the biological activity of the active ingredient, but are themselves not significantly biologically active. Adjuvants assist with the effectiveness of the active ingredient such as, for example, by improving the delivery and uptake of an herbicide into a target weed plant leading to improved biological control.

Adjuvants, in the form of solids or liquids, can be added to a formulated agricultural product, such as a granule, to provide improved performance of the product upon application. Commonly used adjuvants may include, for example, surfactants, spreaders, petroleum and plant derived oils and solvents and wetting agents. Examples of commonly used adjuvants include, but are not limited to, paraffin oil, horticultural spray oils (e.g., summer oil), methylated rape seed oil, methylated soybean oil, highly refined vegetable oil and the like, polyol fatty acid esters, polyethoxylated esters, ethoxylated alcohols, alkyl polysaccharides and blends, amine ethoxylates, sorbitan fatty acid ester ethoxylates, polyethylene glycol esters, organosilicone based surfactants, ethylene vinyl acetate terpolymers, ethoxylated alkyl aryl phosphate esters and the like. These and other adjuvants are described in the “Compendium of Herbicide Adjuvants, 9th Edition,” edited by Bryan Young, Dept. of Plant, Soil and Agricultural Systems, Southern Illinois University MC-4415, 1205 Lincoln Drive, Carbondale, Ill. 62901, which is available for viewing on the internet at http://www.herbicide-adjuvants.com/.

The term “built-in adjuvant” refers to one or more adjuvants that have been added to a particular formulation, such as a granule or liquid formulation, at the manufacturing stage of the product, rather than at the point of use of the product such as, for example, to a spray solution. The use of built-in adjuvants simplifies the use of agrochemical products for the end-user by reducing the number of ingredients that must be individually measured and applied. However, loading limitations and physio-chemical properties of active ingredients can make it challenging to add an adjuvant to a composition. Efforts to prepare pesticidal formulations with built-in alkyl polyglucosides amongst other adjuvants, have recently been disclosed, for example, in WO2010/049070A2 and WO2008/066611.

Described herein are methods of improving the dispersion properties in water of a pesticide-containing granule and compositions of such a granule. The described granule exhibits improved physical stability and improved dispersibility in water.

### SUMMARY

Provided herein are methods of improving the dispersion properties in water of a pesticide-containing granule which comprise:

a) providing a powder comprising a pesticide active ingredient;

b) adding water to the powder;

c) blending the powder and the water into a mixture; and

d) processing the mixture into granules;

wherein the improvement is characterized by incorporating one or more water soluble agglomeration suppressants into the powder or the water prior to blending, wherein the amount of the one or more agglomeration suppressants added is at least the amount required to achieve 50% of its saturated concentration in the amount of water added in step (b).

Also provided are pesticide-containing granules with improved dispersion properties in water which comprise:

a) from about 10 grams per kilogram (gai/kg) to about 900 gai/kg of the pesticide active ingredient, with respect to the total composition;

b) from about 20 grams per kilogram (g/kg) to about 900 g/kg of a water soluble agglomeration suppressant, with respect to the total composition; and

c) from about 10 g/kg to about 300 g/kg of at least one of a solid anionic and a solid non-ionic surfactant, with respect to the total composition.

The composition may optionally include one or more additional inert formulation ingredients.

Also provided is a pesticide-containing granule with improved dispersion properties in water in which the pesticide is fluroxypyr-meptyl.

Also provided are methods of controlling undesirable vegetation, fungal pathogens, bacteria or insects which comprise adding the pesticide-containing granule with improved dispersion properties in water to a carrier such as water and using the resulting water solution containing the dispersed pesticidal active ingredient for spray applications to control the undesirable vegetation, fungal pathogens, bacteria or insects in crop or non-crop environments.

### DETAILED DESCRIPTION

Solid pesticidal compositions, such as granules (GR) and water dispersible granules (WG), containing high concentrations of agricultural active ingredients can be difficult to produce and store due to their tendency to physically degrade when subjected to the range of temperatures and shear stress normally encountered during processing and storage. In addition, these compositions may also suffer from poor dispersion in water and poor delivery of the active ingredient to the locus of the pest requiring control or elimination.

Stable granules are generally defined as those that are stable physically and chemically to the environments in which they are produced and stored, and deliver acceptable levels of biological efficacy when used within defined periods of time.

Described herein are methods of improving the dispersion properties in water of a pesticide-containing granule and compositions thereof. The methods involve the use of a novel, water-soluble agglomeration suppressant as a component of the aqueous binder solution that is used in the process to prepare the pesticide-containing granule from the powder containing the pesticide active ingredient. The described granule exhibits improved physical stability and improved dispersibility in water.

The disclosed methods and compositions provide water dispersible granules with improved properties for dispersion in water which comprise a pesticide active ingredient, a water soluble agglomeration suppressant, at least one of a solid anionic or non-ionic surfactant and, optionally, one or more additional inert formulation ingredients.

The powder containing the pesticide active ingredient used in the methods described herein may include a powdered form of the pesticide active ingredient or a suitable composition thereof. Exemplary compositions of the pesticide active ingredient may include, for example, an air-milled pesticide active ingredient, a spray-dried pesticide active ingredient, a spray-dried, microencapsulated pesticide active ingredient or a solid carrier containing the pesticide active ingredient, with each suitable composition optionally containing one or more additional inert ingredients. The pesticide active ingredient may be in the form of a liquid or a solid. Liquid or very low melting pesticide active ingredients may be microencapsulated or absorbed onto solid carriers in order to form stable, water dispersible granules with improved properties for dispersion in water. The methods provided herein are particularly well suited for the preparation of granule formulations containing pesticide active ingredients that are either liquids at room temperature or have low melting points (less than about 100° C.) and would normally be difficult to process into stable granules with acceptable dispersibility in water.

The pesticide active ingredient for use in the methods and compositions described herein may be selected from one or more of an herbicide, an insecticide, a fungicide, a bactericide and an herbicide safener. The pesticide active ingredient comprises, with respect to the total composition, from about 10 gai/kg to about 900 gai/kg, in some embodiments from about 20 gai/kg to about 850 gai/kg, and in some embodiments from about 50 gai/kg to about 750 gai/kg.

Suitable herbicide active ingredients for use in the methods and compositions described herein and derivatives thereof may be selected from, but are not limited to, one or more of 4-CPA, 4-CPB, 4-CPP, 2,4-D, 3,4-DA, 2,4-DB, 3,4-DB, 2,4-DEB, 2,4-DEP, 3,4-DP, 2,4,5-T, 2,4,5-TB, 2,3,6-TBA, allidochlor, acetochlor, acifluorfen, aclonifen, alachlor, alloxydim, alorac, ametridione, ametryn, amibuzin, amicarbazone, amidosulfuron, aminocyclopyrachlor, aminopyralid, aminopyralid, amiprofos-methyl, amitrole, anilofos, anisuron, asulam, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicylopyrone, bifenox, bilanafos, bilanafos, bispyribac, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cafenstrole, cafenstrole, cambendichlor, carbasulam, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, clomeprop, cloprop, cloproxydim, clopyralid, clopyralid, cloransulam, CPMF, CPPC, credazine, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinitramine, dinofenate, dinoprop, dinosam, dinoseb, dinoterb, diphenamid, dipropetryn, diquat, disul, dithiopyr, diuron, DMPA, DNOC, EBEP, eglinazine, endothal, epronaz, epronaz, EPTC, erbon, esprocarb, ethalfluralin, ethametsulfuron, ethidimuron, ethiolate, ethofumesate, ethoxyfen, ethoxysulfuron, etinofen, etnipromid, etnipromid, etnipromid, etobenzanid, EXD, fenasulam, fenasulam, fenasulam, fenoprop, fenoxaprop, fenoxaprop-P, fenoxasulfone, fenteracol, fenthiaprop, fentrazamide, fenuron, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupoxam, flupropacil, flupropanate, flupyrsulfuron, fluridone, flurochloridone, fluroxypyr, flurtamone, fluthiacet, fomesafen, fomesafen, foramsulfuron, fosamine, furyloxyfen, glufosinate, glyphosate, halosafen, halosafen, halosulfuron, haloxydine, haloxyfop, haloxyfop-P, hexazinone, imazamethabenz, imazamox, imazapic, imazapyr, imazaquin, imazethapyr, imazosulfuron, indanofan, indaziflam, iodobonil, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MCPA, MCPA-thioethyl, MCPB, mecoprop, mecoprop-P, medinoterb, mefenacet, mefluidide, mesoprazine, mesosulfuron, mesotrione, metam, metamifop, metamifop, metamitron, metazachlor, metazosulfuron, metflurazon, methabenzthiazuron, methalpropalin, methazole, methiobencarb, methiozolin, methiuron, methiuron, methometon, methoprotryne, methyldymron, metobenzuron, metobromuron, metolachlor, S-metolachlor, metosulam, metoxuron, metribuzin, metsulfuron, molinate, monalide, monisouron, monochloroacetic acid, monolinuron, monuron, morfamquat, naproanilide, napropamide, naptalam, neburon, nicosulfuron, nipyraclofen, nitralin, nitrofen, nitrofluorfen, norflurazon, noruron, OCH, orbencarb, orthosulfamuron, oryzalin, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentanochlor, pentoxazone, perfluidone, pethoxamid, phenisopham, phenmedipham, phenmedipham-ethyl, phenobenzuron, picloram, picloram, picolinafen, picolinafen, pinoxaden, piperophos, pretilachlor, primisulfuron, procyazine, prodiamine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, sebuthylazine, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr and triclopyr, thidiazimin, thidiazuron, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, tridiphane, trietazine, trifloxysulfuron, trifluralin, triflusulfuron, trifop, trifopsime, trihydroxytriazine, trimeturon, tripropindan, tritac, tritosulfuron, vernolate, xylachlor and compounds of the following Formula

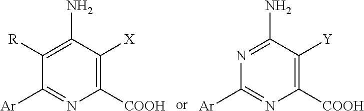

wherein

Ar represents a phenyl group substituted with one to four substituents independently selected from halogen, C₁-C₆ alkyl, C₁-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O— or —OCH₂CH₂O—;

R represents H or F;

X represents Cl or vinyl; and

Y represents Cl, vinyl or methoxy;

and their salts and esters as disclosed, for example, in U.S. Pat. No. 7,314,849 B2, U.S. Pat. No. 7,300,907 B2, U.S. Pat. No. 7,786,044 B2 and U.S. Pat. No. 7,642,220 B2.

In some embodiments, the herbicide active ingredient and derivatives thereof is 2,4-D, 2,4-DB, aminocyclopyrachlor, aminopyralid, bromoxynil, chlorsulfuron, clethodim, clodinafop, clopyralid, cyhalofop, dicamba, fenoxaprop, florasulam, fluazifop, fluazifop-P, fluroxypyr, glufosinate, glyphosate, haloxyfop, haloxyfop-R, imazamox, imazapic, iodosulfuron, ioxynil, MCPA, mesosulfuron, mesotrione, metamifop, metosulam, metsulfuron, penoxsulam, picloram, pinoxaden, propaquizafop, pyroxsulam, quinclorac, quizalofop, sethoxydim, thifensulfuron-methyl, tribenuron, triclopyr, or compounds of the following Formula

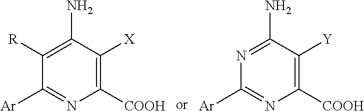

wherein

Ar represents a phenyl group substituted with one to four substituents independently selected from halogen, C₁-C₆ alkyl, C₁-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O—, or —OCH₂CH₂O—;

R represents H or F; X represents Cl or vinyl; and Y represents Cl, vinyl or methoxy;

and their salts and esters.

Additional exemplary herbicide active ingredients for use in the methods and compositions described herein is the compound of the Formula

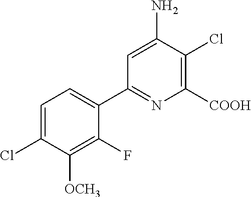 [SMILES: COc1c(Cl)ccc(-c2cc(N)c(Cl)c(C(=O)O)n2)c1F]

and its C₁-C₆ alkyl esters or salt derivatives such as, for example, the methyl ester, and the compound of the Formula

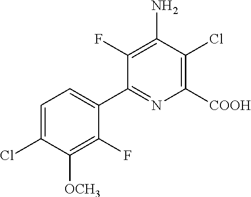 [SMILES: COc1c(Cl)ccc(-c2nc(C(=O)O)c(Cl)c(N)c2F)c1F]

and its C₁-C₁₂ alkyl or C₇-C₁₂ arylalkyl ester or salt derivatives such as, for example, the benzyl ester.

In some embodiments, the active ingredient is fluroxypyr-meptyl.

Exemplary insecticide active ingredients for use in the methods and compositions described herein and derivatives thereof include, but are not limited to, one or more of abamectin, acephate, acetamiprid, acethion, acetoprole, acrinathrin, alanycarb, aldicarb, aldoxycarb, allethrin, allosamidin, allyxycarb, amidithion, aminocarb, amiton, amitraz, anabasine, athidathion, azadirachtin, azamethiphos, azinphos-ethyl, azinphos-methyl, azothoate, barthrin, bendiocarb, benfuracarb, bensultap, bifenthrin, bioallethrin, bioethanomethrin, biopermethrin, bioresmethrin, bistrifluron, bromfenvinfos, bromophos, bromophos-ethyl, bufencarb, buprofezin, butacarb, butathiofos, butocarboxim, butonate, butoxycarboxim, cadusafos, carbanolate, carbaryl, carbofuran, carbophenothion, carbosulfan, cartap, chlorantraniliprole (rynaxypyr), chlordimeform, chlorethoxyfos, chlorfenapyr, chlorfenvinphos, chlorfluazuron, chlormephos, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, coumaphos, coumithoate, crotamiton, crotoxyphos, crufomate, cyanofenphos, cyanophos, cyanthoate, cyantranilipole, cyazypyr, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, cyromazine, cythioate, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, dialifos, diazinon, dicapthon, dichlofenthion, dichlorvos, dicresyl, dicrotophos, dicyclanil, diflubenzuron, dimefluthrin, dimefox, dimethoate, dimethrin, dimethylvinphos, dimetilan, dimitan, dinex, dinoprop, dinosam, dinotefuran, diofenolan, dioxabenzofos, dioxacarb, dioxathion, disulfoton, dithicrofos, DNOC, doramectin, α-ecdysone, ecdysterone, emamectin, EMPC, empenthrin, endothion, EPN, epofenonane, eprinomectin, esfenvalerate, etaphos, ethiofencarb, ethion, ethiprole, ethoate-methyl, ethoprophos, etofenprox, etrimfos, EXD, famphur, fenamiphos, fenazaflor, fenazaquin, fenchlorphos, fenethacarb, fenfluthrin, fenitrothion, fenobucarb, fenoxacrim, fenoxycarb, fenpirithrin, fenpropathrin, fenpyroximate, fensulfothion, fenthion, fenthion-ethyl, fenvalerate, fipronil, flonicamid, flubendiamide, flubendiamide, flucofuron, flucycloxuron, flucythrinate, flufenerim, flufenoxuron, flufenprox, fluvalinate, tau-fluvalinate, fonofos, formetanate, formothion, formparanate, fosmethilan, fospirate, fosthietan, furathiocarb, furethrin, halfenprox, halofenozide, heptenophos, heterophos, hexaflumuron, hydramethylnon, hydroprene, hyquincarb, imicyafos, imidacloprid, imidacloprid, imiprothrin, indoxacarb, IPSP, isazofos, isocarbophos, isofenphos, isoprocarb, isoprothiolane, isothioate, isoxathion, ivermectin, jasmolin I, jasmolin II, jodfenphos, juvenile hormone I, juvenile hormone II, juvenile hormone III, kinoprene, lepimectin, leptophos, d-limonene, lirimfos, lufenuron, lythidathion, malathion, malonoben, mazidox, mecarbam, mecarphon, menazon, mephosfolan, mesulfenfos, metaflumizone, methacrifos, methamidophos, methidathion, methiocarb, methocrotophos, methomyl, methoprene, methoxyfenozide, metofluthrin, metolcarb, metoxadiazone, mevinphos, mexacarbate, milbemectin, milbemycin oxime, mipafox, monocrotophos, morphothion, moxidectin, naftalofos, naled, nicotine, nifluridide, nitenpyram, nitenpyram, nithiazine, nitrilacarb, novaluron, noviflumuron, omethoate, oxamyl, oxydemeton-methyl, oxydeprofos, oxydisulfoton, parathion, parathion-methyl, penfluron, permethrin, phenkapton, phenothrin, phenthoate, phorate, phosalone, phosfolan, phosmet, phosmet, phosnichlor, phosphamidon, phoxim, phoxim-methyl, pirimetaphos, pirimicarb, pirimiphos-ethyl, pirimiphos-methyl, prallethrin, precocene I, precocene II, precocene III, primidophos, profenofos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, sophamide, spinetoram, spinosad, 21-butenyl spinosyns, spirodiclofen, spiromesifen, spirotetramat, sulcofuron, sulfotep, sulfoxaflor, sulprofos, tazimcarb, tebufenozide, tebufenpyrad, tebupirimfos, teflubenzuron, tefluthrin, temephos, TEPP, terallethrin, terbufos, tetrachlorvinphos, tetramethrin, tetramethrin, thiacloprid, thiamethoxam, thicrofos, thiocarboxime, thiocyclam, thiodicarb, thiofanox, thiometon, thiosultap, thuringensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb and zolaprofos. Especially suitable insecticide active ingredients and derivatives thereof include chlorpyrifos, chlorpyrifos-methyl, clothianidin, cyazypyr, lambda-cyhalothrin, deltamethrin, dinotefuran, flonicamid, flubendiamide, imidacloprid, rynaxypyr, spinetoram, spinosad, 21-butenyl spinosyns, sulfoxaflor and thiacloprid.

Exemplary fungicide active ingredients for use in the methods and compositions described herein and derivatives thereof include, but are not limited to, one or more of ametoctradin, amisulbrom, ampropylfos, anilazine, antimycin, azaconazole, azithiram, azoxystrobin, barium polysulfide, Bayer 32394, benalaxyl, benodanil, benomyl, benquinox, bentaluron, benthiavalicarb-isopropyl, benzamacril; benzamacril-isobutyl, benzamorf, benzylaminobenzene-sulfonate (BABS) salt, binapacryl, biphenyl, bismerthiazol, bitertanol, bixafen, blasticidin-S, boscalid, bromuconazole, bupirimate, buthiobate, BYF 1047, captafol, captan, carbamorph, carbendazim, carboxin, carpropamid, carvone, CECA, chlobenthiazone, chloraniformethan, chlorfenazole, 1-chloro-2,4-dinitronaphthalene, chloroneb, chlorothalonil, chlorquinox, chlozolinate, climbazole, copper bis(3-phenylsalicylate), coumarin, cuprobam, cyazofamid, cyclafuramid, cyflufenamid, cymoxanil, cypendazole, cyproconazole, cyprodinil, cyprofuram, dazomet, debacarb, decafentin, diammonium ethylenebis (dithiocarb-amate), dichlofluanid, dichlone, dichloran, 3-(4-chlorophenyl)-5-methylrhodanine, dichlorophen, (RS)-N-(3,5-dichlorophenyl)-2-(methoxymethyl)-succinimide, N-3,5-dichlorophenylsuccinimide, 1,3-dichloro-1,1,3,3-tetrafluoroacetone hydrate, dichlozoline, diclobutrazol, diclocymet, diclomezine, diethofencarb, difenoconazole, difenzoquat ion, diflumetorim, dimethirimol, dimethomorph, dimoxystrobin, diniconazole, diniconazole-M, dinocap, dinocton, dinosulfon, dinoterbon, diphenylamine, dipyrithione, ditalimfos, dithianon, dodemorph, dodemorph acetate, dodicin, dodine, dodine free base, drazoxolon, EBP, edifenphos, enestrobin, epoxiconazole, ESBP, etaconazole, etem, ethaboxam, ethirim, ethoxyquin, N-ethylmercurio-4-toluenesulfonanilide, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluotrimazole, fluoxastrobin, fluquinconazole, flusilazole, flusulfamide, flutolanil, flutriafol, fluxapyrad, folpet, formaldehyde, fosetyl, fosetyl-aluminium, fuberidazole, furalaxyl, furametpyr, furcarbanil, furconazole, furconazole-cis, furmecyclox, furophanate, glyodine, griseofulvin, guazatine, guazatine acetates, GY-81, halacrinate, 2-(2-heptadecyl-2-imidazolin-l-yl)ethanol, Hercules 3944, hexaconazole, hexylthiofos, 8-hydroxyquinoline sulfate, hymexazol, ICIA0858, IK-1140, imazalil, imazalil sulfate, imibenconazole, iminoctadine, iminoctadine triacetate, iminoctadine tris(albesilate), ipconazole, iprobenfos, iprodione, iprovalicarb, isopamphos, isoprothiolane, isopyrazam, isotianil, isovaledione, kasugamycin, kasugamycin hydrochloride hydrate, kresoxim-methyl, mancopper, mancozeb, mandipropamid, maneb, mebenil, mecarbinzid, mefenoxam, mepanipyrim, mepronil, meptyl dinocap, meptyldinocap, metalaxyl, metazoxolon, metconazole, methasulfocarb, methfuroxam, methylmercury dicyandiamide, metiram, metominostrobin, metrafenone, metsulfovax, mildiomycin, milneb, mucochloric anhydride, myclobutanil, myclozolin, nabam, natamycin, nickel bis(dimethyldithiocarbamate), N-3-nitrophenylitaconimide, nitrothal-isopropyl, nuarimol, OCH, octhilinone, ofurace, orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, 2-phenylphenol, phosdiphen, phthalide, picoxystrobin, polyoxin B, polyoxins, polyoxorim, potassium hydroxyquinoline sulfate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraxostrobin, pyrazophos, pyribencarb, pyributicarb, pyridinitril, pyrifenox, pyrimethanil, pyriofenone, pyrometostrobin, pyroquilon, pyroxychlor, pyroxyfur, quinacetol; quinacetol sulfate, quinazamid, quinconazole, quinoclamine, quinoxyfen, quintozene, rabenzazole, Reynoutria sachalinensis extract, salicylanilide, sedaxane, silthiofam, simeconazole, sodium 2-phenylphenoxide, sodium pentachlorophenoxide, spiroxamine, SSF-109, sultropen, SYP-048, SYP-Z048, SYP-Z071, tebuconazole, tebufloquin, tecnazene, tecoram, tetraconazole, thiabendazole, thiadifluor, thicyofen, thifluzamide, thiochlorfenphim, 2-(thiocyanatomethylthio)-benzothiazole, thiophanate, thiophanate-methyl, thioquinox, thiram, tiadinil, tioxymid, tolclofos-methyl, tolylfluanid, triadimefon, triadimenol, triamiphos, triarimol, triazbutil, triazoxide, trichlamide, tricyclazole, tridemorph, trifloxystrobin, triflumizole, triforine, triticonazole, UK-2A, derivatives of UK-2A such as, for example, (3S,6S,7R,8R)-8-benzyl-3-(3-(isobutyryloxymethoxy)-4-methoxypicolinamido)-6-methyl-4,9-dioxo-1,5-dioxonan-7-yl isobutyrate which has a CAS Registry Number of 328255-92-1, urbacid, validamycin, valifenate, valiphenal, vinclozolin, XRD-563, zarilamid, zineb, ziram and zoxamide. Especially suitable fungicide active ingredients and derivatives thereof include azoxystrobin, bixafen, boscalid, carbendazim, carpropamid, chlorothalonil, epoxiconazole, fenbuconazole, fenpropidin, fenpropimorph, fluoxastrobin, flusilazole, fluxapyrad, isopyrazam, isotianil, kasugamycin, meptyldinocap, metconazole, metrafenone, myclobutanil, orysastrobin, penconazole, pencycuron, penthiopyrad, picoxystrobin, probenazole, prochloraz, propiconazole, prothioconazole, pyraclostrobin, quinoxyfen, spiroxamine, tebuconazole, thifluzamide, triadimefon, tricyclazole, tridemorph, trifloxystrobin and validamycin.

Exemplary herbicide safeners for use in the methods and compositions described herein include, but are not limited to, one or more of the following active ingredients and derivatives thereof such as benoxacor, benthiocarb, cloquintocet, daimuron, dichlormid, dicyclonon, dimepiperate, fenchlorazole, fenclorim, flurazole, fluxofenim, furilazole, Harpin proteins, isoxadifen, mefenpyr, mephenate, MG 191, MON 4660, naphthalic anhydride (NA), oxabetrinil, R29148 and N-phenyl-sulfonylbenzoic acid amides.

Exemplary bactericides for use in the methods and compositions described herein include, but are not limited to, one or more of the following such as bronopol, dichlorophen, kasugamycin, nitrapyrin, octhilinone, oxolinic acid, streptomycin, tecloftalam, 8-hydroxyquinoline, sulfaquinoxaline, oxytetracycline, copper octanoate and 2-(thiocyanatomethylthio)benzothiazole, and derivatives thereof. An especially suitable bactericide is nitrapyrin.

The water soluble agglomeration suppressant used in the methods and compositions described herein generally has high water solubility (greater than about 20 weight %; w/w basis). In some embodiments, the solubility is at least 20, 30, 40, 50 or 60 weight %; w/w basis. Examples of agglomeration suppressants include, but are not limited to ionic compounds such as, for example, inorganic salts of inorganic and organic acids, highly oxygenated compounds such as, for example, carbohydrates and nitrogen-containing compounds such as, for example, nitrogen fertilizers. Suitable ionic compounds include alkali metal, magnesium, calcium and ammonium salts of inorganic and organic acids such as hydrochloric acid, sulphuric acid, nitric acid, phosphoric acid, carbonic acid, acetic acid and the like. Exemplary carbohydrates include, but are not limited to monosaccharides, disaccharides, oligosaccharides, polysaccharides and mixtures thereof. The carbohydrates may include, for example, glucose, fructose, sucrose, trehalose, lactose and maltose, dextrines and starches. Suitable nitrogen fertilizers may include urea, ammonium sulfate, ammonium nitrate, potassium chloride, polymers containing or derived from urea, and the like.

In some embodiments, the water soluble agglomeration suppressant is a salt of an inorganic or organic acid. In certain embodiments, the water soluble agglomeration suppressant is a salt of an inorganic acid. In some embodiments, the agglomeration suppressant is an alkali metal, alkali earth metal, or ammonium salt. In some embodiments, the agglomeration suppressant is a sulfate, nitrate, or citrate salt. In certain embodiments, the agglomeration suppressant is magnesium sulfate or ammonium nitrate. In some embodiments, the water soluble agglomeration suppressant is ammonium sulfate. In some embodiments, the water soluble agglomeration suppressant is carbohydrate. In some embodiments, the agglomeration suppressant is a salt of an inorganic acid or organic acid, including alkali metal, magnesium, calcium and ammonium salts of inorganic and organic acids such as hydrochloric acid, sulphuric acid, nitric acid, phosphoric acid, carbonic acid, acetic acid and the like such as, for example, sodium chloride, potassium chloride, magnesium chloride, calcium chloride, ammonium chloride, sodium sulfate, potassium sulfate, magnesium sulfate, sodium nitrate, potassium nitrate, monosodium phosphate, mono-, di- and tripotassium phosphate, sodium carbonate, sodium bicarbonate, potassium carbonate, potassium bicarbonate, sodium acetate, potassium acetate and ammonium acetate; fertilizers such as, for example, ammonium sulfate, mono-, di- and triammonium phosphate, ammonium nitrate and urea; monosaccharides such as glucose, fructose, galactose, xylose and ribose; disaccharides such as sucrose, lactose, trehalose and maltose; and mixtures of any of the agglomeration suppressants described herein. The agglomeration suppressant of the present invention is present in an amount, with respect to the total composition, from about 20 g/kg to about 900 g/kg. In some embodiments, the suppressant is present in an amount from about 20 g/kg to about 800 g/kg. In some embodiments, the suppressant is present in an amount from about 20 g/kg to about 750 g/kg.

The water soluble agglomeration suppressant is normally used at a very high concentration in the aqueous binder solution. The aqueous binder solution is at least 50% saturated with the agglomeration suppressant. In certain embodiments, it is at least 70% saturated with the agglomeration suppressant. In certain embodiments, it is at least 80% saturated with the agglomeration suppressant. In certain embodiments where processing the dough into the granules with improved dispersion properties in water is conducted at higher temperatures (greater than room temperature), an adjustment of the concentration of the agglomeration suppressant in the aqueous binder solution may be made in order to compensate for the increased solubility of the agglomeration suppressant in water at temperatures above room temperature. The agglomeration suppressant reduces or inhibits the agglomeration or coagulation of the components of the granule during processing of the dough into the granule, especially at temperatures above room temperature, and thereby improves the dispersion properties of the granule in water. The agglomeration suppressant may also reduce or inhibit the agglomeration or coagulation of the components of the granule during high shear processing conditions such as, for example, the high shear processing conditions encountered during high shear extrusion of the dough into the stable, high quality granules with improved dispersion properties in water.

The methods of incorporation of the agglomeration suppressant may be readily determined by those of ordinary skill in the art. Exemplary methods include, but are not limited to: (1) dissolving the agglomeration suppressant in water; (2) adding a dry form of the agglomeration suppressant into the powder containing the active ingredient formed in step (a); or (3) utilizing a powder already containing the agglomeration suppressant utilized in step (a). The powder already containing the agglomeration suppressant can be made, e.g., by adding the agglomeration suppressant into the processing steps of generating the powder.

In some embodiments, the blended mixture of water, agglomeration suppressant, and powder containing active ingredient is processed via a high-shear granulation process. In some embodiments, the process is via extrusion.

The compositions described herein include at least one of a solid anionic or solid non-ionic surfactant. Solid anionic surfactants that may be used include, but are not limited to, lignosulfonates, alkyl naphthalene sulfonate formaldehyde condensates, dialkylsulphosuccinate salts and alkylsulfonate salts. Solid non-ionic surfactants that may be used include, but are not limited to, polyvinyl alcohols, polyacrylates, polyethylene oxides, polyvinylpyrrolidones and co-polymers, derivatives and mixtures thereof, polyol fatty acid esters, polyethoxylated esters, polyethoxylated alcohols, alkyl polysaccharides such as alkyl polyglycosides (APG-type) and blends thereof, amine ethoxylates, sorbitan fatty acid ester ethoxylates, and sucrose esters of fatty acids.

In some embodiments, the solid anionic and solid non-ionic surfactants for use in the methods and compositions described herein are polyvinyl alcohols derived from the hydrolysis of polyvinyl acetate, that vary in the degree of hydrolysis from about 87% to about 99%, of which Celvol® 205 (Sekisui Chemical Co., Ltd., Dallas, Tex.) is an example, alkyl polyglycosides (APG-type) of which Agnique® PG 9116 (Cognis, Cincinnati, Ohio) is an example, lignosulfonates of which Borresperse® NA (registered trademark of Borregaard LignoTech) and Polyfon® F (MeadWestvaco, Richmond, Va.) are examples and alkyl naphthalene sulfonate formaldehyde condensates of which Morwet® D425 (AkzoNobel, Chicago, Ill.) is an example, and co-polymers, derivatives and mixtures thereof. The at least one solid anionic or solid non-ionic surfactant is present in an amount, with respect to the total composition, from about 10 g/kg to about 250 g/kg, preferably from about 10 g/kg to about 150 g/kg and most preferably from about 20 g/kg to about 150 g/kg.

The described compositions may optionally include one or more additional inert ingredients such as, but not limited to, adjuvants, antifoam agents, antimicrobial agents, compatibilizing agents, corrosion inhibitors, dispersing agents, dyes, emulsifying agents, neutralizing agents and buffers, odorants, penetration aids, sequestering agents, spreading agents, stabilizers, sticking agents, suspension aids and the like.

Adjuvants that may optionally be included in the described compositions (also known in the art as built-in adjuvants) include those that provide improved biological efficacy on pests such as, for example, weeds, insects, fungal pathogens and the like. Suitable built-in adjuvants are solids at ambient temperature and may include one or more of a non-ionic surfactant. Non-ionic surfactants that may be used as built-in adjuvants include, but are not limited to, polyol fatty acid esters, polyethoxylated esters, polyethoxylated alcohols, alkyl polysaccharides such as alkyl polyglycosides (APG-type) and blends thereof, amine ethoxylates, sorbitan fatty acid ester ethoxylates and sucrose esters of fatty acids.

In one embodiment, provided herein is a method of improving the dispersion properties in water of a pesticide-containing granule which comprises:

a) providing a powder comprising a pesticide active ingredient;

b) adding water to the powder;

c) blending the powder and the water into a mixture; and

d) processing the mixture into granules;

wherein the improvement is characterized by incorporating one or more water soluble agglomeration suppressants into the powder or the water prior to blending, wherein the amount of the one or more agglomeration suppressants is at least the amount required to achieve 50% of its saturated concentration in the amount of water added in step (b).
(i) wherein the pesticide active ingredient is 2,4-D, 2,4-DB, aminocyclopyrachlor, aminopyralid, bromoxynil, chlorsulfuron, clethodim, clodinafop, clopyralid, cyhalofop, dicamba, fenoxaprop, florasulam, fluazifop, fluazifop-P, fluroxypyr, glufosinate, glyphosate, haloxyfop, haloxyfop-R, imazamox, imazapic, iodosulfuron, ioxynil, MCPA, mesosulfuron, mesotrione, metamifop, metosulam, metsulfuron, penoxsulam, picloram, pinoxaden, propaquizafop, pyroxsulam, quinclorac, quizalofop, sethoxydim, thifensulfuron-methyl, tribenuron, triclopyr, a the compound of formula I

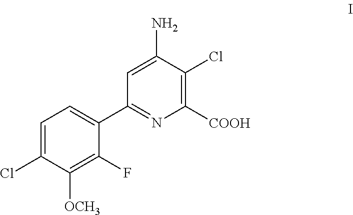 [SMILES: COc1c(Cl)ccc(-c2cc(N)c(Cl)c(C(=O)O)n2)c1F]

or a C₁-C₆ alkyl ester of salt thereof,
or a compound of formula II

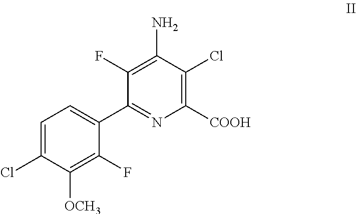 [SMILES: COc1c(Cl)ccc(-c2nc(C(=O)O)c(Cl)c(N)c2F)c1F]

or a C₁-C₁₂ alkyl or C₇-C₁₂ arylalkyl ester or salt thereof;
(ii) the one or more water soluble agglomeration suppressant is an alkali metal, alkali earth metal, ammonium, sulfate, nitrate, or citrate salt; and
(iii) the amount of the one or more agglomeration suppressants is at least the amount required to achieve 70% of its saturated concentration in the amount of water added in step (b).

In one embodiment, provided herein is a method of improving the dispersion properties in water of a pesticide-containing granule which comprises:

e) providing a powder comprising a pesticide active ingredient;

f) adding water to the powder;

g) blending the powder and the water into a mixture; and

h) processing the mixture into granules;

wherein the improvement is characterized by incorporating one or more water soluble agglomeration suppressants into the powder or the water prior to blending, wherein the amount of the one or more agglomeration suppressants is at least the amount required to achieve 50% of its saturated concentration in the amount of water added in step (b).
(i) wherein the pesticide active ingredient is fluroxypyr meptyl;
(ii) the one or more water soluble agglomeration suppressant is magnesium sulfate, ammonium sulfate, or ammonium nitrate; and
(iii) the amount of the one or more agglomeration suppressants is at least the amount required to achieve 70% of its saturated concentration in the amount of water added in step (b).

In one embodiment, provided herein is a method of improving the dispersion properties in water of a pesticide-containing granule which comprises:
i) providing a powder comprising a pesticide active ingredient;
j) adding water to the powder;

k) blending the powder and the water into a mixture; and

l) processing the mixture into granules;

wherein the improvement is characterized by incorporating one or more water soluble agglomeration suppressants into the powder or the water prior to blending, wherein the amount of the one or more agglomeration suppressants is at least the amount required to achieve 50% of its saturated concentration in the amount of water added in step (b).
(iv) wherein the pesticide active ingredient is fluroxypyr meptyl;
(v) the one or more water soluble agglomeration suppressant is magnesium sulfate, ammonium sulfate, or ammonium nitrate; and
(vi) the amount of the one or more agglomeration suppressants is at least the amount required to achieve 70% of its saturated concentration in the amount of water added in step (b);
(vii) the processing in step (d) is performed by utilizing a high-shear granulation process.

In some embodiments, the method of producing a pesticide-containing granule comprises the steps of

(i) Adding water to a powder, wherein
a. the powder comprises a pesticide active ingredient;
b. one or more water soluble agglomeration suppressants are incorporated into one of the water or powder, wherein the amount of the incorporated water soluble agglomeration suppressant is at least the amount required to achieve 50% of its saturated concentration in the amount of the water added;

(ii) blending the powder and water into a mixture; and

(iii) processing the mixture into granules.

An example of a method of improving the dispersion properties in water of a pesticide-containing granule comprises:

a) providing a powder containing spray-dried, microencapsulated fluroxypyr-meptyl;

b) adding water to the powder;

c) blending the powder and the water into a mixture; and

d) processing the mixture into granules;

wherein the improvement is characterized by incorporating ammonium sulfate into the water prior to blending, wherein the amount of the ammonium sulfate is at least the amount required to achieve 50% of its saturated concentration in the amount of water added in step (b).

Provided herein are also pesticide-containing granules with improved dispersion properties in water which comprise:

d) from about 10 grams per kilogram (gai/kg) to about 900 gai/kg of the pesticide active ingredient, with respect to the total composition;

e) from about 20 grams per kilogram (g/kg) to about 900 g/kg of a water soluble agglomeration suppressant, with respect to the total composition; and

f) from about 10 g/kg to about 300 g/kg of at least one of a solid anionic and a solid non-ionic surfactant, with respect to the total composition.

In some embodiments, the granule comprises from about 100-300 g/kg of the water soluble agglomeration suppressant. In some embodiments, the granule comprises from about 50-400 g/kg of the water soluble agglomeration suppressant.

In some embodiments, the granule comprises from about 50-600 g/kg of the water soluble agglomeration suppressant. In some embodiments, the granule comprises from about 100-700 g/kg of the water soluble agglomeration suppressant. In some embodiments, the granule comprises at least 20, 50, 100, 150, 200, 250, 300, 400, or 500 g/kg of the water soluble agglomeration suppressant.

In some embodiments, the granule comprises at least 20 g/kg of the of at least one of a solid anionic and a solid non-ionic surfactant. In some embodiments, the granule comprises at least 40 g/kg of the of at least one of a solid anionic and a solid non-ionic surfactant. In some embodiments, the granule comprises at least 60 g/kg of the of at least one of a solid anionic and a solid non-ionic surfactant. In some embodiments, the granule comprises at least 80 g/kg of the of at least one of a solid anionic and a solid non-ionic surfactant. In some embodiments, the granule comprises at least 100 g/kg of the of at least one of a solid anionic and a solid non-ionic surfactant. In some embodiments, the granule comprises at least 150 g/kg of the of at least one of a solid anionic and a solid non-ionic surfactant.

In some embodiments, the pesticide-containing granule with improved dispersion properties in water which comprises:

a) from about 10 grams per kilogram (gai/kg) to about 900 gai/kg fluroxypyr meptyl, with respect to the total composition;

b) comprises at least 200 g/kg of the water soluble agglomeration suppressant; and

c) at least about 60 g/kg of the at least one of a solid anionic and a solid non-ionic surfactant.

Another embodiment concerns the pesticide-containing granule with improved dispersion properties in water in which the pesticide is fluroxypyr-meptyl. An example of a pesticide-containing granule containing the herbicide fluroxypyr-meptyl comprises:

a) from about 10 grams active ingredient per kilogram (gai/kg) to about 900 gai/kg of microencapsulated fluroxypyr-meptyl, with respect to the total composition;

b) from about 10 grams per kilogram (g/kg) to about 900 g/kg of ammonium sulfate, with respect to the total composition;

c) from about 10 g/kg to about 300 g/kg of a polyvinyl alcohol, with respect to the total composition;

d) from about 10 g/kg to about 300 g/kg of an APG surfactant, with respect to the total composition;

e) from about 10 g/kg to about 150 g/kg of Pergopak M, with respect to the total composition; and

f) from about 10 g/kg to about 100 g/kg of Polyfon F, with respect to the total composition.

Microencapsulated, low-melting or liquid pesticidal active ingredients are prepared by employing interfacial polycondensation encapsulation technology. Use of encapsulation technology in the formulation of agricultural active ingredients is well known to those skilled in the art. See, for example, P. J. Mulqueen in, “Chemistry and Technology of Agrochemical Formulations,” D. A. Knowles, editor, (Kluwer Academic Publishers, 1998), pages 132-147, and references cited therein for a discussion of the use of microencapsulation in the formulation of pesticide active ingredients. In general, microcapsules can be prepared by an interfacial polycondensation between at least one oil soluble monomer selected, for example, from the group consisting of: diisocyanates and polyisocyanates and at least one water soluble monomer selected, for example, from the group consisting of diamines and polyamines. Exemplary microcapsule formulations may be derived from the interfacial polycondensation between polyisocyanates and diamines to provide polyurea microcapsule compositions.

Microencapsulated pesticidal active ingredients may be prepared by first emulsifying an organic phase comprised of the molten active ingredient, optionally containing an oil solvent, and an oil soluble monomer in an aqueous phase comprised of suitable surfactants and water. The emulsion may be formed by homogenizing the oil-water mixture by the use of low or high pressure homogenization until the desired size of oil droplets suspended in the water is obtained. The water soluble monomer is then added to the mixture and reacts with the oil soluble monomer at the water-oil interface of the oil droplets to form the capsule wall enclosing some or the entire oil droplet. For example, by carefully adjusting the length of time that the mixture is homogenized and/or by adjusting the speed or pressure of the homogenizer, it is possible to produce microencapsulated oils of varying capsule sizes (diameter) and wall thicknesses. Similarly, the amount of monomer, cross-linking agents, emulsifying agents, buffer, and the like can be adjusted to create microencapsulated formulations having varying capsule sizes and wall thicknesses that can be readily prepared by one of normal skill in the art.

Microcapsule suspensions of pesticide active ingredients generally include capsules with average diameters that range from about 0.1 micron (μ) to about 20μ, preferably from about 1μ to about 15μ.

The polymeric capsule wall of microencapsulated pesticide active ingredients may comprise from about 0.5 to about 20 weight percent, and in some embodiments, from about 2 to about 10 weight percent of the total weight of the microcapsule and its oil contents.

The core of a microcapsule containing a pesticide active ingredient may preferably be comprised of the liquid or solid pesticidal active ingredient, optionally dissolved in a water immiscible solvent, such as but not limited to, one or more of petroleum distillates such as aromatic hydrocarbons derived from benzene, such as toluene, xylenes, other alkylated benzenes and the like, and naphthalene derivatives; aliphatic hydrocarbons such as hexane, octane, cyclohexane, and the like; mineral oils from the aliphatic or isoparaffinic series, and mixtures of aromatic and aliphatic hydrocarbons; halogenated aromatic or aliphatic hydrocarbons; vegetable, seed or animal oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like, and C₁-C₆ mono-esters derived from vegetable, seed or animal oils; dialkyl amides of short and long chain, saturated and unsaturated carboxylic acids; C₁-C₁₂ esters of aromatic carboxylic acids and dicarboxylic acids, and C₁-C₁₂ esters of aliphatic and cyclo-aliphatic carboxylic acids.

The core of a microcapsule containing a pesticide active ingredient may optionally be used as a carrier for additional pesticides or other ingredients. These pesticides or other ingredients, may be dissolved or dispersed in the oil, and may be selected from acaricides, algicides, antifeedants, avicides, bactericides, bird repellents, chemosterilants, fungicides, herbicide safeners, herbicides, insect attractants, insecticides, insect repellents, mammal repellents, mating disrupters, molluscicides, plant activators, plant growth regulators, rodenticides, synergists, defoliants, desiccants, disinfectants, semiochemicals, and virucides.

Oil soluble monomers used to prepare microencapsulated, agricultural active ingredients may include diisocyanates and polyisocyanates. Exemplary oil soluble monomers include, but are not limited to PAPI® 27 (The Dow Chemical Company, Midland, Mich.), isophorone diisocyanate and hexamethylene diisocyanate, and mixtures thereof.

Water soluble monomers used to prepare microencapsulated, agricultural active ingredients may include the groups consisting of diamines and polyamines. Exemplary water soluble monomers include, are not limited to diamines such as, for example, ethylenediamine.

Water soluble or dispersible surfactants used to prepare the microencapsulated pesticide active ingredients may be anionic, cationic or nonionic in character and can be employed as emulsifying agents, wetting agents, dispersing agents, or for other purposes. Suitable surfactants include, but are not limited to, lignosulfonates such as, for example, Kraftsperse® 25M (MeadWestvaco, Richmond, Va.), alkyl polyglycosides (APG) such as, for example, Agnique®PG 9116 (Cognis, Cincinnati, Ohio), polymethyl methacrylate-polyethylene glycol graft copolymers such as, for example, Atlox® 4913 (Croda, Edison, N.J.) and alcohol ethoxylates such as, for example, Tergitol® 15-S-7 (The Dow Chemical Company, Midland, Mich.).

Also provided are methods of controlling undesirable vegetation, fungal pathogens, bacteria or insects which comprise adding the pesticide-containing granule with improved dispersion properties in water to a carrier such as water and using the resulting water solution containing the dispersed pesticidal active ingredient for spray applications to control the undesirable vegetation, fungal pathogens, bacteria or insects in crop or non-crop environments.

Water dispersible granule formulations can be produced using one or more of the following processing methods: (1) pan or drum granulation, (2) mixing agglomeration, (3) extrusion granulation, (4) fluid bed granulation or (5) spray drying granulation. The physico-chemical properties of the active ingredient and additives are important to consider when choosing a process to use. G. A. Bell and D. A. Knowles in, “Chemistry and Technology of Agrochemical Formulations,” D. A. Knowles, editor, (Kluwer Academic Publishers, 1998), pages 41-114, describe the types of granules used in agricultural chemical formulations and provide many references to the production of these solid formulations.

In addition to the compositions and uses set forth above, the described compositions also embrace the composition and use of the pesticidal granules in conjunction with one or more other pesticides to control a wider variety of undesirable pests. When used in conjunction with other pesticides, the presently claimed pesticidal granules can be formulated with the other pesticide or pesticides, tank mixed with the other pesticide or pesticides or applied sequentially with the other pesticide or pesticides. In addition, the pesticidal granules may, optionally, be combined with or blended with other pesticide granule compositions containing additional active ingredients to form a composition containing, for example, a physically uniform blend of granules. This blend of pesticide granules may be used to control undesirable weeds and other pests in crops and non-crop environments.

In addition to the compositions and uses set forth above, the described compositions also embrace the composition and use of these pesticidal granules in combination with one or more additional compatible ingredients. Other additional compatible ingredients may include, for example, one or more agrochemical active ingredients, adjuvants, fertilizers, growth regulators and pheromones and any other additional ingredients providing functional utility, such as, for example, surfactants, dyes, stabilizers, fragrants and dispersants.

The herbicidal granules of the described compositions can additionally be employed to control undesirable vegetation in many crops that have been made tolerant to or resistant to them or to other herbicides by genetic manipulation or by mutation and selection. The herbicidal granules of the present invention can, further, be used in conjunction with glyphosate, glufosinate, dicamba, imidazolinones or 2,4-D on glyphosate-tolerant, glufosinate-tolerant, dicamba-tolerant, imidazolinone-tolerant or 2,4-D-tolerant crops. It is generally preferred to use the herbicidal granules of the present invention in combination with herbicides that are selective for the crop being treated and which complement the spectrum of weeds controlled by the herbicidal granules at the application rate employed. It is further generally preferred to apply the herbicidal granules of the invention and other complementary herbicides at the same time, either as a combination formulation or as a tank mix. Similarly, the herbicidal granules of the present invention can be used in conjunction with acetolactate synthase inhibitors on acetolactate synthase inhibitor tolerant crops.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLE 1

### Preparation of a Granule with Improved Dispersion Properties in Water Containing a High-load of Fluroxypyr-Meptyl

A high-load, stable, fluroxypyr-meptyl dry powder formulation was prepared by spray drying a microencapsulated oil-in-water emulsion as described herein. The oil phase of the oil-in-water emulsion was prepared by dissolving 3.440 g of polyisocyanate (PAPI® 27; The Dow Chemical Company, Midland, Mich.) in 67.303 g of molten floroxypyr-meptyl technical (melting point: ca. 58° C.) at 70° C. The aqueous phase of the oil-in-water emulsion was prepared by dissolving 17.301 g of a 20 wt % aqueous solution of polyvinyl alcohol (PVA; Celvol® 205; Sekisui Specialty Chemicals America LLC, Dallas, Tex.) and 3.042 g of a 50 wt % solution of an alkylated polyglucoside (APG) solution (Agnique® PG 9116; Cognis, Cincinnati, OH) in 60.846 g of deionized (DI) water at 70° C. The oil phase was slowly added into the aqueous phase while mixing with a Silverson high shear mixer for 5-10 minutes at approximately 3000 to 5000 rpm to produce a fine emulsion with suspended oil droplets with a volume average mean diameter (d(0.5)) of about 2.5 μm. The aqueous emulsion contains 50.161 wt % of water, 2.278 wt % of PVA, 1.001 wt % of APG, 44.300 wt % of fluroxypyr tech, and 2.262 wt % of PAPI 27. Once the desired emulsion size was obtained, 2.736 g of a 30 wt % aqueous solution of ethylenediamine was added dropwise into the mixture over a period of about 2-3 minutes. The mixture was then kept at 70° C. for about 1 hour with Silverson mixing to form microcapsules with a capsule wall thickness of about 25 nm. The microencapsulated oil droplets were further stabilized by adding an additional 39.744 g of 20 wt % aqueous Celvol® 205 PVA to the microcapsule suspension. An aqueous solution of 0.380 g of 50 wt % APG (Agnique® PG 9116), 5.704 g of Pergopak® M (Albemarle Corp., Baton Rouge, La,), 9.612 g of Polyfon® F (MeadWestvaco, Richmond, Va.) and 233.607 g of DI water were added to the microcapsule suspension. The final aqueous microcapsule suspension containing 22.5 wt % solids in water and maintained at 70° C. was dried in a spray drier (BUCHI 290) at a feed rate of 300 ml/hr and inlet/outlet temperatures of about 135° C./80° C., respectively. The dried powder (Powder A) obtained had a volume median diameter (d(0.5)) of 4.8 microns (μm) upon re-dispersion in water. Powder A (15 g) was uniformly mixed with 10.016 g of 37.5 wt % saturated aqueous ammonium sulfate (AMS) binder solution to achieve a moisture level of ˜25 wt % in the wetted powder. The wetted powder was extruded with a Fitzpatrick basket extruder (model number KAR-75) to produce 2 batches of wet granules using 0.8 mm and 1 mm screens. The wet granules were dried in an oven at 30 to 50° C. The dried granules (Granules A) typically contain about 3 wt % of residual water. Following a similar procedure to that described above, a second sample of extruded granules (Granules B) were prepared with water alone as the binder. The compositions of the granules are compared in Table 1. The size range of the particles produced from the dried granules upon dispersion in water is tabulated in Table 2. Table 3 shows a comparison of the dispersion times of extruded granules prepared with water alone as the binder or the AMS solution as the binder. Extruded granules (both 0.8 and 1.0 mm sizes) prepared with the AMS solution as the binder disperse quickly upon dilution in water (<120 seconds) at ambient temperature or 5° C. and also provide excellent stability to active ingredient crystal growth upon re-dispersion in water for >24 hours.

TABLE 1
Composition of Granules A and Granules B Containing Fluroxypyr-
meptyl and Prepared by Extruding Powder A With a Saturated
Aqueous AMS Solution or Water Alone as the Binder.

| | Granules A | Granules B |
|---|---|---|
| Ingredients | (wt %) | (wt %) |
| Fluroxypyr-meptyl (a.i.) | 53.826 | 67.303 |
| PAPI 27 | 2.751 | 3.440 |
| Ethylenediamine (EDA) | 0.656 | 0.821 |
| PVA (CELVOL 205) | 9.124 | 11.409 |
| APG(Agnique PG 9116) | 1.368 | 1.711 |
| Pergopak M | 4.562 | 5.704 |
| Polyfon F | 7.687 | 9.612 |
| Ammonium sulfate | 20.026 | 0.000 |
| (AMS) | | |

TABLE 2
Particle Size Comparison of Extruded Granules A Dried at Various
Temperatures and Powder A After Dispersion in 21° C. Water.

| | |
|---|---|
| Drying | Particle size upon |
| temperature | dilution in water (μm) |

| Sample | (° C.) | d(0.5) | d(0.9) |
|---|---|---|---|
| Powder A | — | 4.8 | 10.3 |
| 0.8 mm Granules A | 30 | 9.6 | 20.8 |
| 0.8 mm Granules A | 50 | 9.9 | 22.0 |
| 1 mm Granules A | 30 | 10.5 | 23.8 |
| 1 mm Granules A | 50 | 11.2 | 27.6 |
| 1 mm Granules A¹ | 50 | 11.9 | 29.4 |

¹After 2 weeks storage at 54° C. (initially dried at 50° C.)

TABLE 3
Dispersion Time in Water at 5° C. for Extruded Granules A
and Extruded Granules B.

| | | Dispersion Time in |
|---|---|---|
| Sample | Binder | Water (sec) |
| Granules A | AMS solution | 120 seconds |
| Granules B | water | did not disperse fully |
| | | within 10 minutes |
| Casino herbicide¹ | unknown | did not disperse fully |
| | | within 10 minutes |

¹Casino herbicide is a 250 gae/kg (360 gai/kg) water dispersible granule (WDG) containing fluroxypyr MHE (AgriGuard).

### EXAMPLE 2

### Use of Granules of the Present Invention for Weed Control

Postemergence Greenhouse Trial Methods: A peat based potting soil, Metro-mix 360, (produced by Sun Gro Horticulture Canada CM Ltd) was used as the soil media for this test. Metro-mix 360 is a growing medium consisting of Canadian sphagnum peat moss, coarse perlite, bark ash, starter nutrient charge (with gypsum) and slow release nitrogen and dolomitic limestone. The exact proportions are proprietary. Several seeds of each species were planted in 10 cm square pots and top watered twice daily. Plant material was propagated in greenhouse zone E2 at a constant temperature of 18 to 20 ° C. and 50 to 60% relative humidity. Natural light was supplemented with 1000-watt metal halide overhead lamps with an average illumination of 500 microeinsteins per square meter per second (μE m⁻² s⁻¹) photosynthetic active radiation (PAR). Day length was 16 hours. Plant material was top-watered prior to treatment and sub-irrigated after treatment. Treatments were applied with a track sprayer manufactured by Allen Machine Works and located in building 306, room E1-483. The sprayer utilized an 8003E spray nozzle, spray pressure of 262 kPa pressure and speed of 2.0 mph to deliver 187 L/Ha. The nozzle height was 46 cm above the plant canopy. The growth stage of the various weed species ranged from 2 to 6 leaf and is listed below by species Application rates were 0, 8.8, 17.5, 35, 70, and 140 g ae/ha. Treatments were replicated 3 times. Plants were returned to the greenhouse after treatment and sub-watered throughout the duration of the experiment. Plant material was fertilized twice weekly with Hoagland's fertilizer solution that is readily available in the greenhouses. Percent visual injury assessments were made on a scale of 0 to 100% as compared to the untreated control plants (where 0 is equal to no injury and 100 is equal to complete death of the plant. The plants tested are listed in Table 4. The results are summarized in Table 5.

TABLE 4
Information Table for the Plant Species Tested with the
Compositions of the Present Invention.

| | | Bayer | Growth Stage at |
|---|---|---|---|
| Common Name | Scientific Name | Code | application |
| Galium | Galium aparine | GALAP | 3 to 4 leaf |
| Common chickweed | Stellaria media | STEME | 4 to 6 leaf |
| Wild buckwheat | Polygonum | POLCO | 2 to 4 leaf |
| | convolvulus | | |
| Soybeans | Glycine max | GLXMA | 1 to 2 trifoliate |

TABLE 5
Percent Weed Control Using a Spray Solution Prepared
from Granule A with Added Tank-mix Adjuvant Agral
90 - 21 days After Application

| | | | % | % | % | % |
|---|---|---|---|---|---|---|
| Sample | Agral | Rate | Control | Control | Control | Control |
| Tested | 90¹ | (g ae/ha) | STEME | GALAP | POLCO | GLXMA |
| Granule A | 0.25% | 8.8 | 45 | 22 | NT² | 18 |
| Granule A | 0.25% | 17.5 | 85 | 99 | 100 | 55 |
| Granule A | 0.25% | 35 | 93 | 99 | 99 | 72 |
| Granule A | 0.25% | 70 | 100 | 100 | 100 | 97 |
| Granule A | 0.25% | 140 | 100 | NT² | NT² | 97 |

¹Agral 90 is a non-ionic surfactant adjuvant available from Norac Concepts Inc.
²NT—Not Tested

What is claimed:

1. A method of improving the dispersion properties in water of a pesticide-containing granule which comprises:
(viii) providing a powder comprising a pesticide active ingredient;
(ix) adding water to the powder;
(x) blending the powder and the water into a mixture; and
(xi) processing the mixture into granules;
wherein the improvement is characterized by incorporating one or more water soluble agglomeration suppressants into the powder or the water prior to blending, wherein the amount of the one or more agglomeration suppressants is at least the amount required to achieve 50% of its saturated concentration in the amount of water added in step (b).

2. The method of claim 1, wherein the pesticide active ingredient is
(a) 2,4-D, 2,4-DB, aminocyclopyrachlor, aminopyralid, bromoxynil, chlorsulfuron, clethodim, clodinafop, clopyralid, cyhalofop, dicamba, fenoxaprop, florasulam, fluazifop, fluazifop-P, fluroxypyr, glufosinate, glyphosate, haloxyfop, haloxyfop-R, imazamox, imazapic, iodosulfuron, ioxynil, MCPA, mesosulfuron, mesotrione, metamifop, metosulam, metsulfuron, penoxsulam, picloram, pinoxaden, propaquizafop, pyroxsulam, quinclorac, quizalofop, sethoxydim, thifensulfuron-methyl, tribenuron, or triclopyr, or ester or salt thereof; or
(b) a compound of formula I 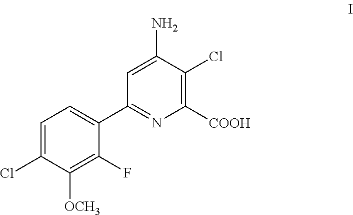 [SMILES: COc1c(Cl)ccc(-c2cc(N)c(Cl)c(C(=O)O)n2)c1F]
or a C₁-C₆ alkyl ester of salt thereof,
or a compound of formula II 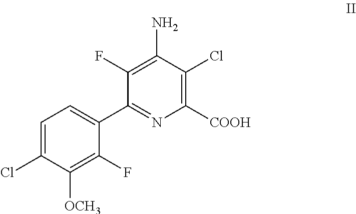 [SMILES: COc1c(Cl)ccc(-c2nc(C(=O)O)c(Cl)c(N)c2F)c1F]
or a C₁-C₁₂ alkyl or C₇-C₁₂ arylalkyl ester or salt thereof.

3. The method of claim 1, wherein the pesticide active ingredient is fluroxypyr-meptyl.

4. The method of claim 1, wherein the one or more water soluble agglomeration suppressant is a salt of an inorganic acid, a salt of an organic acid, or a carbohydrate.

5. The method of claim 1, wherein the one or more water soluble agglomeration suppressant is an alkali metal, alkali earth metal, ammonium, sulfate, nitrate, or citrate salt.

6. The method of claim 1, wherein the agglomeration suppressant is magnesium sulfate, ammonium sulfate, or ammonium nitrate.

7. The method of claim 1, wherein the amount of the one or more agglomeration suppressants is at least the amount required to achieve 70% of its saturated concentration in the amount of water added in step (b).

8. The method of claim 1, wherein the processing in step (d) is performed by utilizing a high-shear granulation process.

9. The method of claim 8, wherein the high-shear granulation process is an extrusion process.

10. The method of claim 1, wherein
a. wherein the pesticide active ingredient is fluroxypyr-meptyl;
b. the one or more water soluble agglomeration suppressant is an alkali metal, alkali earth metal, ammonium, sulfate, nitrate, or citrate salt; and
c. the processing in step (d) is performed by utilizing a high-shear granulation process.

11. A method of producing a pesticide-containing granule comprises the steps of
(i) adding water to a powder, wherein
a. the powder comprises a pesticide active ingredient;
b. one or more water soluble agglomeration suppressants are incorporated into one of the water or powder, wherein the amount of the incorporated water soluble agglomeration suppressant is at least the amount required to achieve 50% of its saturated concentration in the amount of the water added;
(ii) blending the powder and water into a mixture; and
(iii) processing the mixture into granules.

12. The method of claim 11, wherein the pesticide active ingredient is fluroxypyr-meptyl.

13. The method of claim 12, wherein
a. the agglomeration suppressant is magnesium sulfate, ammonium sulfate, or ammonium nitrate;
b. the amount of the one or more agglomeration suppressants is at least the amount required to achieve 70% of its saturated concentration in the amount of water added in step (b); and
c. the processing in step (iii) is performed by utilizing a high-shear granulation process.

14. A pesticide-containing granule with improved dispersion properties in water which comprises:
a) from about 10 grams per kilogram (gai/kg) to about 900 gai/kg of the pesticide active ingredient, with respect to the total composition;
b) from about 20 grams per kilogram (g/kg) to about 900 g/kg of a water soluble agglomeration suppressant, with respect to the total composition; and
c) from about 10 g/kg to about 300 g/kg of at least one of a solid anionic and a solid non-ionic surfactant, with respect to the total composition

15. The granule of claim 14, wherein the granule comprises at least 200 g/kg of the water soluble agglomeration suppressant.

16. The granule of claim 14, wherein the granule comprises at least about 60 g/kg of the at least one of a solid anionic and a solid non-ionic surfactant.

17. The granule of claim 14, wherein the pesticide active ingredient is fluroxypyr-meptyl.

18. The granule of claim 14, wherein the pesticide active ingredient is
(a) 2,4-D, 2,4-DB, aminocyclopyrachlor, aminopyralid, bromoxynil, chlorsulfuron, clethodim, clodinafop, clopyralid, cyhalofop, dicamba, fenoxaprop, florasulam, fluazifop, fluazifop-P, fluroxypyr, glufosinate, glyphosate, haloxyfop, haloxyfop-R, imazamox, imazapic, iodosulfuron, ioxynil, MCPA, mesosulfuron, mesotrione, metamifop, metosulam, metsulfuron, penoxsulam, picloram, pinoxaden, propaquizafop, pyroxsulam, quinclorac, quizalofop, sethoxydim, thifensulfuron-methyl, tribenuron, or triclopyr, or an ester or salt thereof; or
(b) a compound of formula I 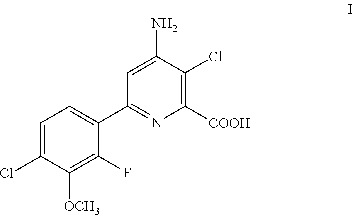 [SMILES: COc1c(Cl)ccc(-c2cc(N)c(Cl)c(C(=O)O)n2)c1F]
or a C₁-C₆ alkyl ester of salt thereof,
or a compound of formula II 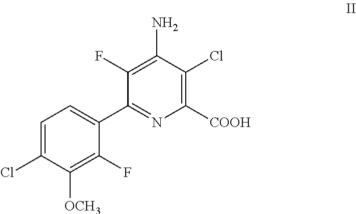 [SMILES: COc1c(Cl)ccc(-c2nc(C(=O)O)c(Cl)c(N)c2F)c1F]
or a C₁-C₁₂ alkyl or C₇-C₁₂ arylalkyl ester or salt thereof.

19. The granule of claim 14, wherein the at least one of a solid anionic and solid non-ionic surfactant is a lignosulfonate, alkyl naphthalene sulfonate formaldehyde condensate, polyvinyl alcohol, or alkyl polyglycosides.

20. The granule of claim 14, wherein
a. the granule comprises at least 200 g/kg of the water soluble agglomeration suppressant;
b. the granule comprises at least about 60 g/kg of the at least one of a solid anionic and a solid non-ionic surfactant;
c. the pesticide active ingredient is fluroxypyr-meptyl; and
d. the at least one of a solid anionic and solid non-ionic surfactant is a lignosulfonate, alkyl naphthalene sulfonate formaldehyde condensate, polyvinyl alcohol, or alkyl polyglycosides.
